(19) United States
(12) Patent Application Publication
(10) Pub. No.: US 2014/0166419 A1
(43) Pub. Date: Jun. 19, 2014

(54) SHUTTLE CAR SPRING-ASSISTED SWINGING SHEAVE BRACKET

(71) Applicant: Joy MM Delaware, Inc., Wilmington, DE (US)

(72) Inventors: James A. Krellner, Franklin, PA (US); Toby J. Cressman, Titusville, PA (US); Ronald K. Dickey, Grove City, PA (US)

(73) Assignee: Joy MM Delaware, Inc., Wilmington, DE (US)

(21) Appl. No.: 14/103,033

(22) Filed: Dec. 11, 2013

Related U.S. Application Data
(60) Provisional application No. 61/737,294, filed on Dec. 14, 2012.

(51) Int. Cl. B65H 59/24; B60L 9/00

(52) U.S. Cl. CPC B65H 59/24; B60L 9/00
USPC 191/12.2 R; 242/155 R

(57) ABSTRACT

A movable machine includes a frame, an electrical motor on the fame, a cable electrically connected to the motor and adapted to be connected to a source of power, and a sheave bracket assembly coupled to the frame. The sheave bracket assembly includes two mounting plates, two spaced apart sheaves rotatably mounted on the mounting plates, a hinged portion coupled to the mounting plates and pivotally coupled to the frame, and at least one biasing member located between the frame and the mounting plates that biases the mounting plates and sheaves toward a first position.

### CROSS-REFERENCE TO RELATED APPLICATIONS

This application claims priority to U.S. Provisional Application No. 61/737,294, filed Dec. 14, 2012, the entire contents of which are incorporated herein by reference.

### FIELD OF THE INVENTION

The present invention relates to movable electronic machinery having a trailing cable connected to a source of power. More particularly, the invention relates to a mechanism for preventing the cable from contacting the movable electrical machinery as the machinery moves forward, backwards, and around corners.

### BACKGROUND OF THE INVENTION

Movable electronic machinery, such as shuttle cars used for carrying mining material in underground mines, have electric motors connected by a cable to a source of power. As the machinery moves backwards, forwards, and around corners, the cable is either wound onto or paid out of a reel.

In order to prevent the cable from contacting the side or the rear of the shuttle car, hinged sheave bracket assemblies with mounting plates and sheaves have been used. These assemblies are affixed to the shuttle car. However, it has been found that when the shuttle car is operating on a grade, the hinged assemblies do not fully return the mounting plates and sheaves to a desired position. Rather, the mounting plates and sheaves remain in a position where the cable contacts and rubs against the shuttle car frame and incurs unwanted wear and damage.

### SUMMARY OF THE INVENTION

According to one construction, a movable machine includes a frame, an electrical motor on the fame, a cable electrically connected to the motor and adapted to be connected to a source of power, and a sheave bracket assembly coupled to the frame. The sheave bracket assembly includes two mounting plates, two spaced apart sheaves rotatably mounted on the mounting plates, a hinged portion coupled to the mounting plates and pivotally coupled to the frame, and at least one biasing member located between the frame and the mounting plates that biases the mounting plates and sheaves toward a first position.

In accordance with another construction, a movable machine includes a sheave bracket assembly having a bracket, a hinged portion pivotally coupled to the bracket, a mounting plate coupled to the hinged portion, a sheave rotatably coupled to the mounting plate, and a biasing member coupled to at least one of the bracket and the hinged portion that biases the mounting plates and sheaves toward a first position.

Other aspects of the invention will become apparent by consideration of the detailed description and accompanying drawings.

### BRIEF DESCRIPTION OF THE DRAWINGS

FIG. 1 is a partial top view of a front right portion of a shuttle car including a sheave bracket assembly in a first position.

FIG. 2 is a partial top view of the shuttle car of FIG. 1, illustrating the sheave bracket assembly in a second position.

FIGS. 3 and 4 are perspective views of the sheave bracket assembly.

FIG. 5 is a perspective view of a portion of the sheave bracket assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited.

### DETAILED DESCRIPTION OF THE INVENTION

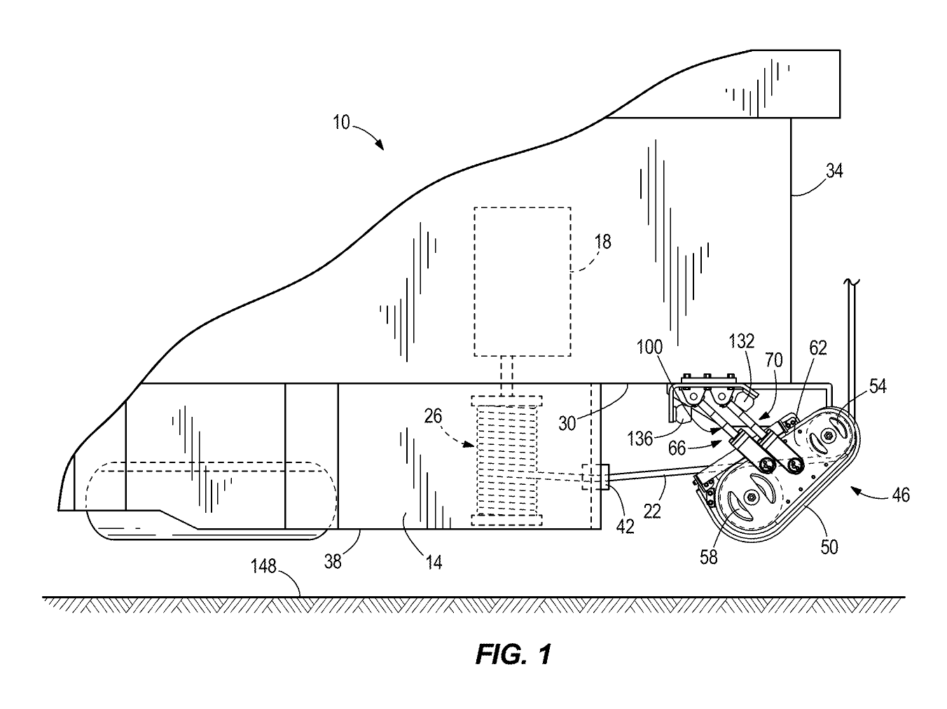

With reference to FIG. 1, a shuttle car 10 is useful in hauling material in an underground mine. The shuttle car 10 includes a frame 14, a motor 18 disposed on the frame 14, and a cable 22 electrically connected to the motor 18 and adapted to be connected to a source of power (not shown). The shuttle car 10 further includes a reel 26 disposed on the frame 14, which provides storage for the cable 22. The reel 26 is located near a front right portion 30 of the shuttle car 10, although other constructions include different locations for the reel 26.

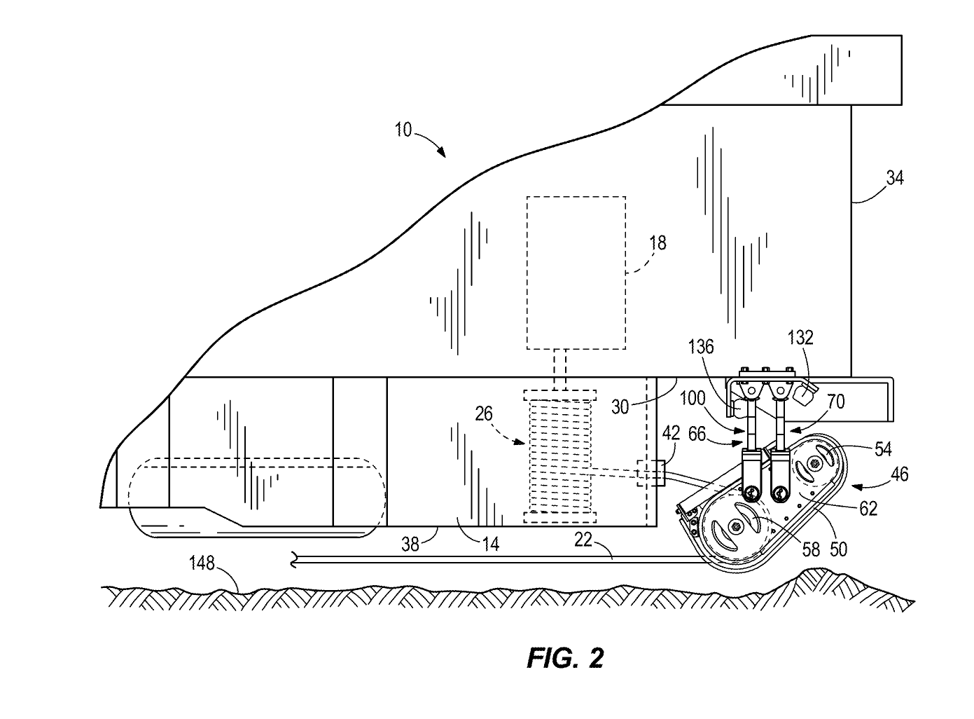

As the shuttle car 10 moves backwards, forwards, and around corners, the cable 22 is either wound onto or paid out of the reel 26. As illustrated in FIG. 2, at times the cable 22 runs along a side portion 38 of the shuttle car 10. As illustrated in FIG. 1, when the shuttle car 10 moves right around a corner, the cable 22 runs along a front portion 34 of the shuttle car 10. In some constructions the cable 22 is between 500 and 750 feet long, although other constructions include different lengths. The shuttle car 10 further includes a spooling device 42 disposed between the reel 26 and the front portion 34, and a sheave bracket assembly 46 mounted on the front right portion 30.

With reference to FIG. 1, the sheave bracket assembly 46 is located substantially within a notched area formed by the front right portion 30.

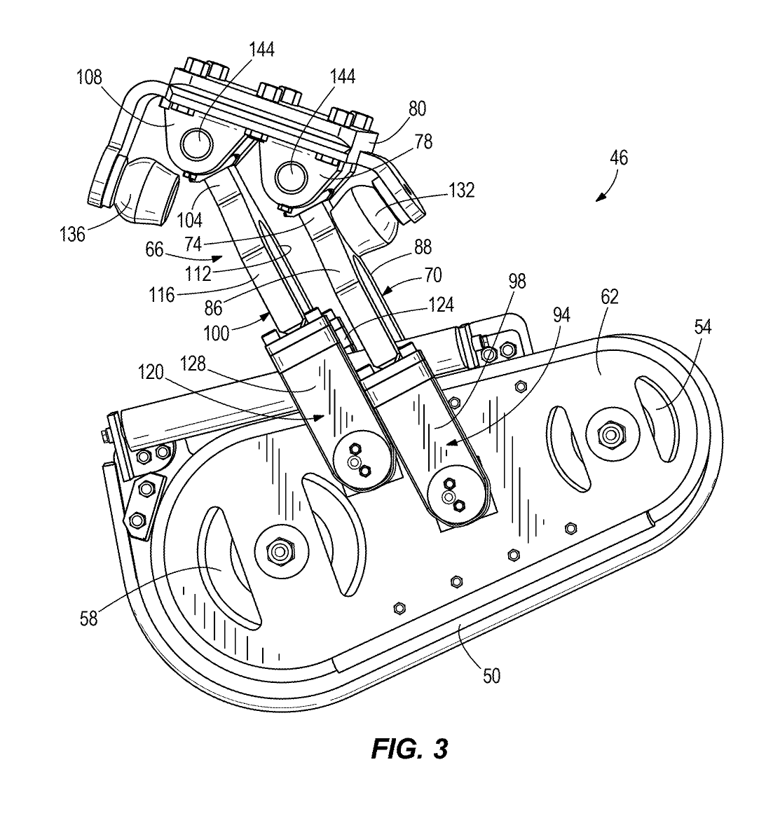

With reference to FIGS. 3-5, the sheave bracket assembly 46 includes a first, lower mounting plate 50, and two spaced apart sheaves 54 and 58 rotatably mounted on the first mounting plate 50. The cable 22 extends from the cable reel 26 through the spooling device 42, and between the sheaves 54 and 58. As illustrated in FIGS. 1 and 2, the rearward-most sheave 54 supports the cable 22 through less than 90 degrees, whereas the other sheave 58 supports the cable 22 through more than 90 degrees. The rearward-most sheave 54 has a smaller diameter than the other sheave 58.

As illustrated in FIGS. 3-5, the sheave bracket assembly 46 further includes a second, upper mounting plate 62 parallel to and spaced apart from the first mounting plate 50. The two spaced apart sheaves 54 and 58 are rotatably mounted on the second mounting plate 62 and between the two mounting plates 50 and 62.

In order to permit the sheave bracket assembly 46 to be small in size, but still prevent the cable 22 from contacting either the front portion 34 of the shuttle car 10 or the side 38 of the shuttle car 10 during movement of the shuttle car 10, the sheave bracket assembly 46 further includes a hinged portion 66 coupling the mounting plates 50 and 62 to the shuttle car 10 for permitting pivotal movement of the mounting plates 50, 62 relative to the frame 14.

With reference to FIGS. 3-5, the hinged portion 66 includes a first Y-shaped arm 70 having a base 74 (FIG. 3) that is coupled to a pivot mount 78 on a bracket 80. The pivot mount 78 and the bracket 80 couple the base 74 to the shuttle car 10. The arm 70 further includes two extensions 86 and 88 that extend from the base 74 to a pivot mount 94. The pivot mount 94 couples the extensions 86, 88 to the mounting plates 62, 50, respectively.

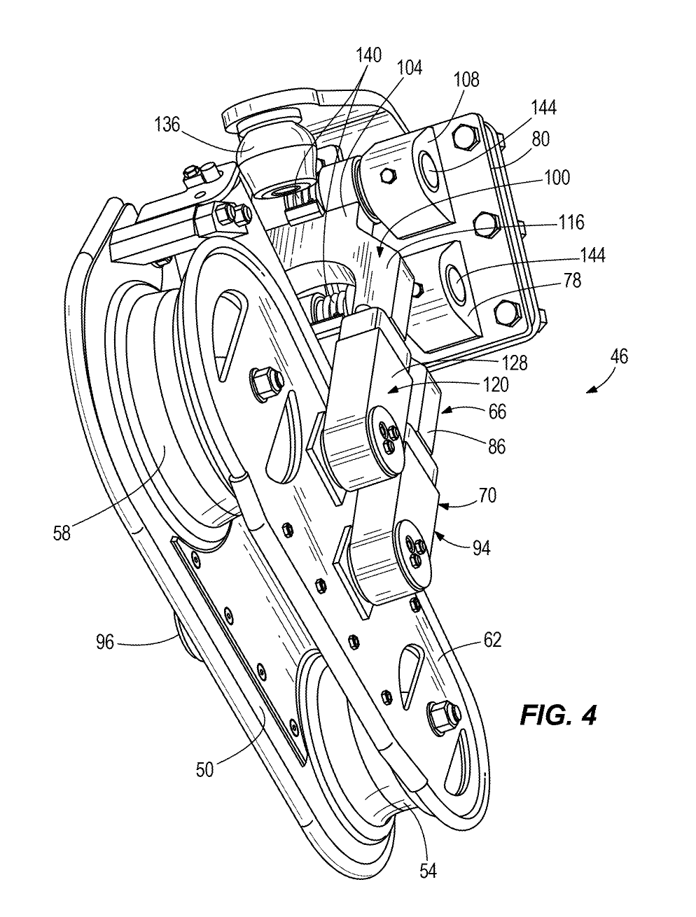

The pivot mount 94 includes a first, lower pivot connection 96 (FIG. 4) that couples the mounting plate 50 to the extension 88, and a second, upper pivot connection 98 (FIG. 3) that couples the mounting plate 62 to the extension 86.

The hinged portion 66 further includes a second Y-shaped arm 100 having a base 104 that is coupled to a pivot mount 108 on the bracket 80. The pivot mount 108 and the bracket 80 couple the base 104 to the shuttle car 10. The arm 100 further includes two extensions 112 and 116 that extend from the base 104 to a pivot mount 120. The pivot mount 120 couples the extensions 112, 116 to the mounting plates 50, 62, respectively.

The pivot mount 120 includes a first, lower pivot connection 124 that couples the mounting plate 50 to the extension 112, and a second, upper pivot connection 128 that couples the mounting plate 62 to the second extension 116.

With reference to FIGS. 1 and 3-5, the first arm 70 and the second arm 100 are configured to be coupled to the frame 14, and the sheave bracket assembly 46 is configured to be located substantially within the notched area formed in front right portion 30 of the frame 14.

With continued reference to FIGS. 3-5, in order to reduce the likelihood of contact between the arms 70 and 100 and the shuttle car 10 causing damage to the arms 70 and 100, the sheave bracket assembly 46 further includes a first resilient stop member 132 coupled to the shuttle car 10 adjacent the pivot mount 78, and a second resilient stop member 136 coupled to the shuttle car 10 adjacent the pivot mount 108. The stop members 132, 136 are disposed on opposite ends of the bracket 80.

With continued reference to FIGS. 1-5, the sheave bracket assembly 46 additionally includes a pair of biasing element 140 to bias the mounting plates 50, 62 and sheaves 54, 58 toward a first position (e.g., a position as illustrated in FIG. 1). The sheave bracket assembly 46 includes two biasing elements 140 in the form of springs. The biasing elements 140 are wrapped around pins 144 that extend through the pivot mounts 78, 108. The pins 144 pivotally mount the arms 70, 100 to the bracket 80, the bracket 80 being rigidly attached to the frame 14.

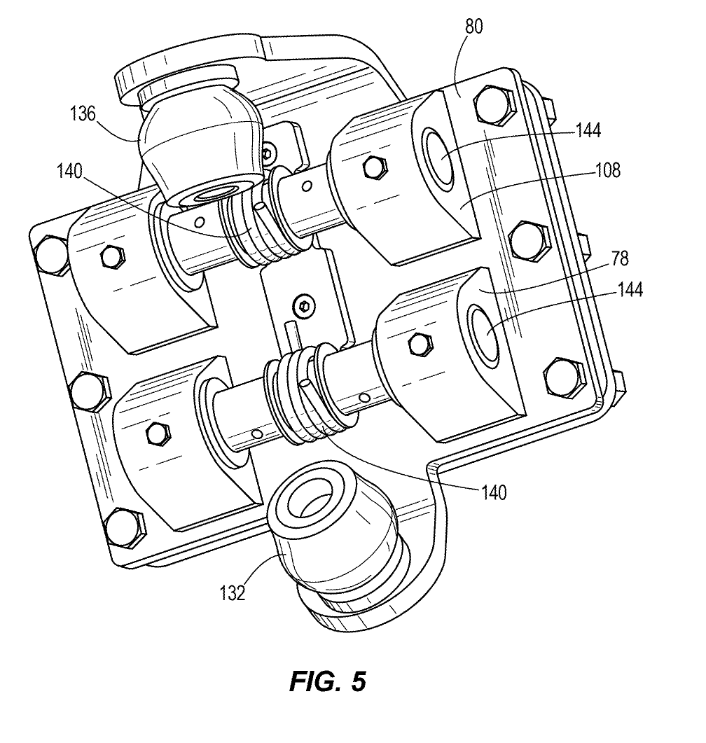

With continued reference to FIGS. 4 and 5, the biasing elements 140 are coupled at one end to the bracket 80, and at the other end to the arms 70, 100. The biasing elements 140 provide a biasing force that resists movement of the mounting plates 50, 62 and the sheaves 54, 58 toward a second position (e.g., a position as illustrated in FIG. 2). Thus, whenever the cable 22 is relaxed, and is not pulling the mounting plates 50, 62 and the sheaves 54, 58 toward the second position (or holding the mounting plates 50, 62 and the sheaves 54, 58 in the second position), the mounting plates 50, 62 and the sheaves 54, 58 will automatically return toward the first position. This helps to ensure that the cable 22 will not unintentionally rub against the frame 14 along the front right portion 30 or the front portion 34 (e.g., when the shuttle car 10 is on a graded surface).

While the illustrated sheave bracket assembly 46 includes biasing elements 140 with ends coupled directly to the bracket 80, in some constructions the biasing elements 140 are instead coupled directly to the frame 14. In some constructions the biasing elements 140 are coupled directly to the bracket 80 or the frame 14, but not directly coupled to the arms 70, 100. The biasing elements 140 may have fixed ends on the bracket 80 or the frame 14, and free ends located adjacent the arms 70, 100, the free ends configured to contact the arms 70, 100 when the arms 70, 100 are moved toward the second position via the cable 22.

Alternatively, in some constructions the biasing elements 140 have fixed ends attached to the arms 70, 100, and free ends adjacent the bracket 80 or the frame 14, the free ends configured to contact the bracket 80 or the frame 14 when the arms 70, 100 are moved toward the second position via the cable 22.

While the illustrated sheave bracket assembly 46 includes two biasing elements 140, in other constructions fewer or more than two biasing elements 140 are used, including one, three, or four biasing elements 140.

Additionally, while the illustrated sheave bracket assembly 46 includes biasing elements 140 that are located about (i.e., wrapped around) pins 144, in some constructions the biasing elements 140 are located elsewhere. For example, in some constructions the biasing elements 140 are located at other locations along the bracket 80, or between the frame 14 and the arms 70, 100. In some constructions the biasing elements 140 are coupled to or located adjacent the mounting plates 50, 62, rather than the arms 70, 100.

Various types of biasing elements 140 may be used, including but not limited to torsional springs, wound springs, compression springs, tension springs, and others. In some constructions, more than one type of biasing element 140 is used on the same sheave bracket assembly 46.

Additionally, the first position and the second position described above may be any one of a number of desired positions. For example, in some constructions the biasing elements 140 are used to bias the mounting plates 50, 62 and the sheaves 54, 58 toward a first position that brings the arms 70, 100 close to, but still not contacting, the stop member 132. In some constructions, the biasing elements 140 bias the mounting plates 50, 62 and the sheaves 54, 58 toward a first position that brings the arms 70, 100 close to, or in contact with, the stop member 136. Other locations and/or orientations are also possible for the first position and second positions.

Furthermore, in some constructions the sheave bracket assembly 46 is coupled to the frame 14 at locations other than that illustrated in FIGS. 1 and 2. For example, rather than being attached along the front right portion 30 of the shuttle car 10, in some constructions the sheave bracket assembly 46 is coupled to the frame 14 along a left rear portion of the shuttle car 10. Other locations are also possible.

In some constructions, in order to give the hinged portion 66 added flexibility to help prevent damage to the assembly 46 in the event of the assembly 46 contacting a mine wall 148 (FIG. 2), and to help absorb shocks to the assembly 46 occasioned by changes in direction of the cable 22, each arm 70, 100 includes flexible wire ropes (examples of which are shown, for example, in U.S. Pat. No. 6,530,537, the entire contents of which is incorporated herein by reference).

Although the invention has been described in detail with reference to certain preferred embodiments, variations and modifications exist within the scope and spirit of one or more independent aspects of the invention as described.

1. A movable machine comprising:
a frame;
an electrical motor coupled to the frame;
a cable coupled to the motor; and
a sheave bracket assembly coupled to the cable, the sheave bracket assembly including two mounting plates, two sheaves rotatably coupled to the mounting plates, a hinged portion coupled to the mounting plates and pivotally coupled to the frame, and two biasing members disposed between the frame and the mounting plates that bias the mounting plates and the sheaves toward a first position.

2. The machine of claim 1, wherein the hinged portion includes two Y-shaped arms and the biasing members are coupled to the arms.

3. The machine of claim 2, wherein one of the one biasing members is coupled to one of the arms, and the other biasing member is coupled to the other arm.

4. The machine of claim 1, wherein the sheave bracket assembly includes two pins, one of the biasing members being wrapped about one of the pins, and the other biasing member wrapped about the other of the pins.

5. The machine of claim 4, wherein the hinged portion includes two arms, and wherein the arms are pivotally coupled to the pins.

6. The machine of claim 1, wherein the sheave bracket assembly includes a bracket coupled to both the hinged portion and the frame, and wherein each of the biasing members is coupled at one end to the bracket and at another end to the arm.

7. The machine of claim 1, wherein the biasing members are springs.

8. The machine of claim 1, wherein the sheave bracket assembly includes a first stop member and a second stop member, and wherein the first position corresponds to a position in which the hinged portion is in contact with the first stop member.

9. The machine of claim 8, wherein the hinged portion is movable to a second position in which the hinged portion is in contact with the second stop member.

10. The machine of claim 1, wherein the frame includes a notch, and wherein the sheave bracket assembly is disposed substantially within the notch.

11. The machine of claim 1, wherein the sheave bracket assembly is coupled to a left, rear portion of the frame.

12. A sheave bracket assembly comprising;
a bracket;
a hinged portion pivotally coupled to the bracket;
a mounting plate coupled to the hinged portion;
a sheave rotatably coupled to the mounting plate; and
a biasing member coupled to the hinged portion that biases the mounting plate and sheave toward a first position.

13. The assembly of claim 12, wherein the biasing member is coupled to both the bracket and the hinged portion.

14. The assembly of claim 12, wherein the hinged portion includes a Y-shaped arm and the biasing member is coupled to the arm.

15. The assembly of claim 12, wherein the assembly includes two biasing members.

16. The assembly of claim 12, further comprising a pin, wherein the biasing member is wrapped about the pin.

17. The assembly of claim 16, wherein the hinged portion includes an arm, and wherein the arm is pivotally coupled to the pin.

18. The assembly of claim 12, wherein the biasing member is a spring.

19. The assembly of claim 12, further comprising a first stop member and a second stop member disposed on the bracket, wherein the first position corresponds to a position in which the hinged portion is in contact with the first stop member.

20. The assembly of claim 19, wherein the hinged portion is movable to a second position in which the hinged portion is in contact with the second stop member.
